(19) United States
(12) Patent Application Publication
(10) Pub. No.: US 2020/0335097 A1
(43) Pub. Date: Oct. 22, 2020

(54) METHOD AND COMPUTER APPARATUS FOR AUTOMATICALLY BUILDING OR UPDATING HIERARCHICAL CONVERSATION FLOW MANAGEMENT MODEL FOR INTERACTIVE AI AGENT SYSTEM, AND COMPUTER-READABLE RECORDING MEDIUM

(71) Applicant: MONEY BRAIN CO., LTD., Seoul (KR)

(72) Inventors: Jaeho SEOL, Seoul (KR); Seyoung JANG, Gyeonggi-do (KR)

(21) Appl. No.: 16/955,202

(22) PCT Filed: Apr. 27, 2018
(86) PCT No.: PCT/KR2018/004923

§ 371 Date: Jun. 18, 2020

(30) Foreign Application Priority Data
Dec. 18, 2017 (KR) 10-2017-0173837

(51) Int. Cl. G10L 15/197; G10L 15/16; G10L 15/22; G10L 15/18; G10L 15/06; G06N 5/04

(52) U.S. Cl. CPC G10L 15/197; G10L 15/16; G10L 15/22; G10L 2015/088; G10L 15/063; G06N 5/043; G10L 15/1815

(57) ABSTRACT

A method according to an embodiment of the present invention includes collecting a plurality of conversation logs related to a service domain, wherein the service domain includes a plurality of intent groups and each of the conversation logs includes a plurality of utterance records, classifying each of the plurality of utterance records into one intent group among the plurality of intent groups, according to a predetermined criterion, grouping utterance records classified into each corresponding intent group, for each of the plurality of intent groups, acquiring a probabilistic distribution of a time-series sequential flow between the plurality of intent groups, based on a sequential flow of the plurality of utterance records in each of the plurality of conversation logs, and building or updating a conversation flow management model for a service so as to include the acquired probabilistic distribution of the time-series sequential flow between the plurality of intent groups.

### 1. TECHNOLOGY FIELD

The present invention relates to an interactive artificial intelligence (AI) agent system, and more particularly, to a method for automatically generating a hierarchical conversation flow management model for an interactive AI agent system.

### 2. BACKGROUND

In recent years, with the development of technology in the field of artificial intelligence, especially in the field of natural language understanding, an interactive AI agent system that allows a user to manipulate a machine in a more human-friendly way, with interaction via natural language in the form of, for example, voice and/or text, without being limited to manipulating the machine by the conventional machine-oriented command input/output method, and to acquire a desired service from the machine has been increasingly developed and utilized. Accordingly, in a variety of fields, including (but not limited to) online consulting centers, online shopping malls, and the like, users can be provided with desired services through an interactive AI agent system that provides natural language interactions in the form of voice and/or text.

In particular, there is an increasing demand for an interactive AI agent system that provides services of more complex domains based on voice input in the form of spontaneous speech, beyond the conventional interactive AI agent system, which only provides a simple question and answer conversation service based on fixed scenarios. In order to provide services of more complex domains based on voice input in the form of spontaneous speech, the interactive AI agent system needs to build and manage a hierarchical conversation flow management model that includes sufficient conversation management knowledge, for example, sequential conversation flow patterns, for providing a service of interest.

### DISCLOSURE

### Technical Problem

A conversation flow management model for an interactive AI agent system has been built and managed generally based on the discretion of an expert and manual classification of data. However, as a number of conversation logs are accumulated and the need to generate and update a conversation flow management model by reflecting the accumulated conversation logs increases, it is become less reliable and efficient to manually build and manage the conversation flow management model. Therefore, there is a need for an efficient and reliable method of building and/or managing a hierarchical conversation flow management model for providing a service of a complex domain by reflecting therein knowledge obtainable from a number of conversation logs.

### Technical Solution

According to one aspect of the present invention, there is provided a method for automatically building or updating a conversation flow management model performed by an interactive artificial intelligence (AI) agent system. The method of the present invention includes: collecting a plurality of conversation logs related to a service domain, wherein the service domain includes a plurality of intent groups and each of the conversation logs includes a plurality of utterance records; classifying each of the plurality of utterance records into one intent group among the plurality of intent groups, according to a predetermined criterion; grouping utterance records classified into each corresponding intent group, for each of the plurality of intent groups; acquiring a probabilistic distribution of a time-series sequential flow between the plurality of intent groups, based on a sequential flow of the plurality of utterance records in each of the plurality of conversation logs; and building or updating a conversation flow management model for a service so as to include the acquired probabilistic distribution of the time-series sequential flow between the plurality of intent groups.

According to one embodiment of the present invention, the acquiring the probabilistic distribution may be performed based on a statistical method or a neural network method.

According to one embodiment of the present invention, each of the plurality of intent groups may be associated with one or more keywords, and wherein the classifying each of the plurality of utterance records into one intent group among the plurality of intent groups may include: determining whether each of the plurality of utterance records includes the one or more keywords associated with each of the plurality of intent groups; and classifying each of the plurality of utterance records into one intent group among the plurality of intent groups, based on the determination.

According to one embodiment of the present invention, the building or updating the conversation flow management model for the service may include causing the conversation flow management model to include the utterance records grouped corresponding to each of the plurality of intent groups.

According to one embodiment of the present invention, the acquiring the probabilistic distribution of the time-series sequential flow between the plurality of intent groups may further include: identifying all sequential flows that can occur between the plurality of intent groups; and determining, from each of the plurality of conversation logs, an occurrence probability of each sequential flow between the plurality of intent groups among all the sequential flows.

According to one embodiment of the present invention, the acquiring the time-series sequential flow between the plurality of intent groups may include acquiring the probabilistic distribution of the time-series sequential flow between the plurality of intent groups by excluding a sequential flow having an occurrence probability thereof less than a threshold from the sequential flows between the plurality of intent groups.

According to another aspect of the present invention, there is provided a computer-readable recording medium having one or more instructions stored thereon which, when executed by a computer, cause the computer to perform one of the above-described methods.

According to still another aspect of the present invention, there is provided a computer apparatus for automatically building or updating a conversation flow management model for an interactive AI agent system. The computer apparatus of the present invention may include a conversation flow management model building/updating unit and a conversation log collecting unit configured to collect and store a plurality of conversation logs related to a service domain, wherein the service domain includes a plurality of intent groups and each of the conversation logs includes a plurality of utterance records. The conversation flow management model building/updating unit of the present invention may be configured to receive the plurality of conversation logs from the conversation log collecting unit, classify each of the plurality of utterance records into one intent group among the plurality of intent groups, according to a predetermined criterion, group utterance records classified into each corresponding intent group, for each of the plurality of intent groups, acquire a probabilistic distribution of a time-series sequential flow between the plurality of intent groups, based on a sequential flow of the plurality of utterance records in each of the plurality of conversation logs, and build or update a conversation flow management model for a service so as to include the acquired probabilistic distribution of the time-series sequential flow between the plurality of intent groups.

### Advantageous Effects

There is provided an efficient method capable of automatically analyzing a number of conversation logs and constructing therefrom a hierarchical conversation flow management model, for example, hierarchical conversation flow patterns related to the provision of service, for providing a service of a complex domain. Accordingly, it is possible to reduce the time and cost for building and updating the hierarchical conversation flow management model and to more easily build the hierarchical conversation flow management model for a new service domain. In addition, a probability distribution of sequential conversation flow for providing a specific service is automatically generated and provided, thereby enabling more efficient conversation management.

### DESCRIPTION OF DRAWING

FIG. 1 is a diagram schematically illustrating a system environment in which an interactive artificial intelligence (AI) agent system can be implemented according to one embodiment of the present invention.

FIG. 2 is a functional block diagram schematically illustrating a functional configuration of a user terminal (102) of FIG. 1 according to one embodiment of the present invention.

FIG. 3 is a functional block diagram schematically illustrating a functional configuration of an interactive AI agent server (106) of FIG. 1 according to one embodiment of the present invention.

FIG. 4 is a functional block diagram schematically illustrating a functional configuration of a conversation/task processing unit (304) of FIG. 3 according to one embodiment of the present invention.

FIG. 5 is a flowchart of exemplary operations performed by a conversation flow management model building/updating unit (306) of FIG. 3 according to one embodiment of the present invention.

FIG. 6 is a diagram illustrating a part of a probability graph of a sequential flow of each intent group of a service, which is constructed according to one embodiment of the present invention.

### MODE FOR INVENTION

Hereinafter, detailed embodiments of the present invention will be described with reference to the accompanying drawings. Detailed descriptions of related well-known functions and configurations that are determined to unnecessarily obscure the gist of the present invention will be omitted. Further, the following descriptions are provided for explaining the exemplary embodiment of the present invention, and the present invention should not be construed as being limited thereto.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein the term “and/or” includes any and all combinations of one or more of the associated listed items. The terms “comprises,” “includes,” and “has” specify the presence of stated features, numbers, steps, operations, elements, components, and/or combinations thereof, but do not preclude the presence or addition of one or more other features, numbers, steps, operations, elements, components and/or combinations thereof.

In the following embodiments, the term, such as “module” or “. . . unit,” indicates a unit for processing at least one function or operation, and this may be implemented by hardware, software, or a combination thereof. In addition, a plurality of “modules” or “. . . units” may be integrated as at least one module and implemented as at least one processor except for a “module” or “. . . unit” needed to be implemented as specific hardware.

In embodiments of the present invention, the term “interactive artificial intelligence (AI) agent system” may refer to an arbitrary information processing system that is capable of receiving a natural language input (e.g., a command, a statement, a request, a question, or the like in natural language from a user) from a user through interactive interactions with the user via natural language in the form of voice and/or text, interpreting the received natural language input to identify an intent of the user, and performing necessary operations based on the found intent of the user, that is, providing an appropriate conversation response and/or performing a task, and the interactive AI agent system is not limited to a specific form. In embodiments of the present invention, the interactive AI agent system may provide a service of a specific domain, wherein a service domain may be configured to include a plurality of subordinate intent groups (e.g., a service domain of product purchase may include subordinate intent groups, such as product inquiry, brand inquiry, design inquiry, price inquiry, return inquiry, and the like). In embodiments of the present invention, operations performed by the interactive AI agent system may be conversation responses and/or task execution that are each carried out according to the user's intent within the sequential flow of the subordinate intent groups for providing a specific service.

In embodiments of the present invention, it should be understood that the conversation response provided by the interactive AI agent system may be provided in various forms, such as visual, auditory, and/or tactile forms (including, but not limited to, for example, voice, sound, text, video, images, symbols, emoticons, hyperlinks, animation, various notifications, motion, haptic feedback, and the like). In embodiments of the present invention, tasks performed by the interactive AI agent system may include various types of tasks including (but not limited to), for example, information search, approval process, message creation, email creation, phone call, music playback, photographing, user location search, map/navigation service, and the like.

In embodiments of the present invention, the interactive AI agent system may include a chatbot system based on a messenger platform, such as a chatbot system which exchanges messages with a user on a messenger and provides various types of information desired by the user or perform a task. However, it should be understood that the present invention is not limited thereto.

In addition, unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the accompanying drawings.

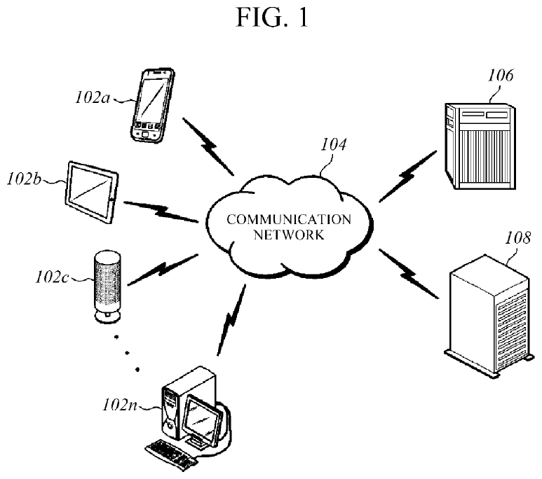

FIG. 1 is a diagram schematically illustrating a system environment 100 in which an interactive AI agent system can be implemented according to one embodiment of the present invention. As illustrated, the system environment 100 includes a plurality of user terminals 102a to 102n, a communication network 104, an interactive AI agent server 106, and an external service server 108.

According to one embodiment of the present invention, each of the plurality of user terminals 102a to 102n may be an arbitrary user terminal having a wired or wireless communication function. Each of the user terminals 102a to 102n may be various types of a wired or wireless communication terminal, including, for example, a smartphone, a tablet PC, a music player, a smart speaker, a desktop computer, a laptop computer, a personal digital assistant (PDA), a game console, a digital TV, a set-top box, but is not limited to a specific type. According to one embodiment of the present invention, each of the user terminals 102a to 102n may communicate (i.e., transmit and receive necessary information) with the interactive AI agent server 106 via the communication network 104. According to one embodiment of the present invention, each of the user terminals 102a to 102n may communicate (i.e., transmit and receive necessary information) with the external service server 108 via the communication network 104. According to one embodiment of the present invention, each of the user terminals 102a to 102n may receive a user input in the form of voice and/or text from the outside and provide an operation result (e.g., provision of a specific conversation response and/or execution of a specific task) corresponding to the user input, which is obtained through communication with the interactive AI agent server 106 and/or the external service server 108 (and/or processing inside the user terminals 102a to 102n), to the user.

According to one embodiment of the present invention, a conversation response as the operation result corresponding to the user input provided by the user terminals 102a to 102n may be provided, for example, according to a conversation flow pattern of a subordinate intent group corresponding to the user input at the time of interest in a sequential flow of the subordinate intent groups for providing a service of interest within a specific service domain. According to one embodiment of the present invention, each of the user terminals 102a to 102n may provide the conversation response as the operation result corresponding to the user input in various forms, such as visual, auditory, and/or tactile forms (including, but not limited to, for example, voice, sound, text, video, images, symbols, emoticons, hyperlinks, animation, various notifications, haptic feedback, and the like). In the embodiment of the present invention, task execution as an operation corresponding to the user input may include execution of various types of tasks including (but not limited to), for example, information search, approval process, message creation, email creation, phone call, music playback, photographing, user location search, map/navigation service, and the like.

According to one embodiment of the present invention, the communication network 104 may include an arbitrary wired or wireless communication network, for example, a transmission control protocol (TCP)/Internet protocol (IP) communication network. According to one embodiment of the present invention, the communication network 105 may include, for example, a Wi-Fi network, a local area network (LAN), an Internet network, and the like, and the present invention is not limited thereto. According to one embodiment of the present invention, the communication network 104 may be implemented using, for example, Ethernet, Global System for Mobile Communications (GSM), enhanced data GSM environment (EDGE), Code-Division Multiple Access (CDMA), Time-Division Multiple Access (TDMA), Bluetooth, VoIP, Wi-MAX, Wibro, and any other various wired or wireless communication protocols.

According to one embodiment of the present invention, the interactive AI agent server 106 may communicate with the user terminals 102a to 102n via the communication network 104. According to one embodiment of the present invention, the interactive AI agent server 106 may be operable to transmit and receive necessary information to and from the user terminals 102a to 102n via the communication network 104 and based on this provide the user with an operation result corresponding to a user input received at the user terminals 102a to 102n, that is, an operation result matching with the user intent. According to one embodiment of the present invention, the interactive AI agent server 106 may receive a user natural language input in the form of voice and/or text from the user terminals 102a to 102n through, for example, the communication network 104, and process the received natural language input based on a prepared knowledge model to determine the user's intent. According to one embodiment of the present invention, the interactive AI agent server 106 may perform an operation corresponding to the determined user intent on the basis of a prepared conversation flow management model. According to one embodiment of the present invention, each operation performed by the interactive AI agent server 106 may be, for example, a conversation response and/or task execution carried out, corresponding to each user's intent, in a sequential flow of subordinate intent groups of a corresponding service domain for providing a specific service.

According to one embodiment of the present invention, the interactive AI agent server 106 may generate a specific conversation response matching with, for example, the user intent and provide the generated conversation response to the user terminals 102a to 102n. According to one embodiment of the present invention, the interactive AI agent server 106 may generate a corresponding conversation response in the form of voice and/or text on the basis of the determined user intent, and transmit the generated response to the user terminals 102a to 102n via the communication network 104. According to one embodiment of the present invention, the conversation response generated by the interactive AI agent server 106 may include other visual elements, such as images, videos, symbols, emoticons, and the like, other auditory elements, such as sound, or other tactile elements, along with a natural language response in the form of voice and/or text described above.

According to one embodiment of the present invention, depending on the type of user input (e.g., voice input or text input) received at the user terminals 102a to 102n, responses of the same form may be generated on the interactive AI agent server 106 (e.g., a voice response is generated when a voice input is given and a text response is generated when a text input is given), but the present invention is not limited thereto. It should be noted that according to another embodiment of the present invention, a response in the form of voice and/or text may be generated and provided regardless of the type of user input.

According to one embodiment of the present invention, the interactive AI agent server 106 may communicate with the external service server 108 via the communication network 104, as described above. The external service server 108 may be, for example, a messaging service server, a online consulting center server, an online shopping mall server, an information search server, a map service server, a navigation service server, or the like, and the present disclosure is not limited thereto. According to one embodiment of the present invention, the conversation response based on the user intent, which is transmitted from the interactive AI agent server 106 to the user terminals 102a to 102n, may include data content which is retrieved and acquired from, for example, the external service server 108.

In the drawing, the interactive AI agent server 106 is illustrated as a separate physical server configured to be capable of communicating with the external service server 108 via the communication network 104, but the present disclosure is not limited thereto. It should be noted that according to another embodiment of the present invention, the interactive AI agent server 106 may be configured to be included as part of various service servers, such as an online consulting center server, an online shopping mall server, and the like.

According to one embodiment of the present invention, the interactive AI agent server 106 may collect conversation logs (including, for example, a plurality of user records and/or system utterance records) through various routes, automatically analyze the collected conversation logs, and generate and/or update a conversation flow management model according to the analysis result. According to one embodiment of the present invention, the interactive AI agent server 106 may classify each utterance record into one of predetermined intent groups through keyword analysis of the conversation logs collected in relation to, for example, a predetermined service domain, and make a probabilistic analysis of a sequential flow distribution between the intent groups.

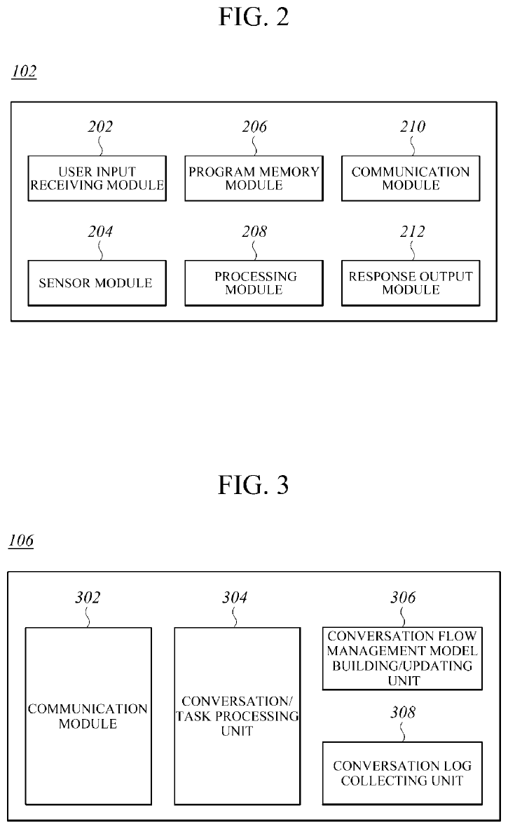

FIG. 2 is a block diagram schematically illustrating a functional configuration of the user terminal 102 illustrated in FIG. 1, according to one embodiment of the present invention. As illustrated, the user terminal 102 includes a user input receiving module 202, a sensor module 204, a program memory module 206, a processing module 208, a communication module 210, and a response output module 212.

According to one embodiment of the present invention, the user input receiving module 202 may receive various forms of input, for example, a natural language input, such as a voice input and/or a text input (and additionally other forms of input, such as a touch input), from a user. According to one embodiment of the present invention, the user input receiving module 202 may include, for example, a microphone and an audio circuit, acquire a user voice input signal through the microphone, and convert the acquired signal into audio data. According to one embodiment of the present invention, the user input receiving module 202 may include various forms of input device, for example, various pointing devices, such as a mouse, a joystick, a trackball, and the like, a keyboard, a touch screen, a stylus, and the like, and acquire a text input and/or a touch input signal, which is received from the user through the input device. According to one embodiment of the present invention, the user input received at the user input receiving module 202 may be associated with execution of a predetermined task, for example, running of a predetermined application or search for predetermined information, but the present invention is not limited thereto. According to another embodiment of the present invention, the user input received by the user input receiving module 202 may require only a simple conversation response regardless of running of a predetermined application or information search. According to another embodiment, the user input received by the user input receiving module 202 may be related to a simple statement for unilateral communication.

According to one embodiment of the present invention, the sensor module 204 may include one or more different types of sensors, and acquire, through these sensors, status information of the user terminal 102, for example, a physical status of the corresponding user terminal 102, software and/or hardware status, or information on an environment status of the user terminal 102. According to one embodiment of the present invention, the sensor module 204 may include, for example, an optical sensor, and detect a change in an ambient light status of the corresponding user terminal 102 through the optical sensor. According to one embodiment of the present invention, the sensor module 204 may include, for example, a movement sensor, and detect, through the movement sensor, whether the corresponding user terminal 102 is moved. According to one embodiment of the present invention, the sensor module 204 may include, for example, a speed sensor and a global positioning system (GPS) sensor, and detect a location and/or an orientation state of the corresponding user terminal 102 through these sensors. It should be noted that according to another embodiment of the present invention, the sensor module 204 may include other various types of sensors, such as a temperature sensor, an image sensor, a pressure sensor, a touch sensor, and the like.

According to one embodiment of the present invention, the program memory module 206 may be an arbitrary storage medium in which various programs executable on the user terminal 102, for example, a variety of application programs and related data, are stored. According to one embodiment of the present invention, in the program memory module 206, various application programs including, for example, a dialing program, an email application, an instant messaging application, a camera application, a music playback application, a video playback application, an image management program, a map application, a browser application, and the like, and data related to execution of theses programs may be stored. According to one embodiment of the present invention, the program memory module 206 may be configured to include various types of volatile or non-volatile memory, such as a dynamic random access memory (DRAM), a static random access memory (SRAM), a double data rate random access memory (DDR RAM), a read-only memory (ROM), a magnetic disk, an optical disk, a flash memory, and the like.

According to one embodiment of the present invention, the processing module 208 may communicate with each component module of the user terminal 102 and perform various operations on the user terminal 102. According to one embodiment of the present invention, the processing module 208 may run and execute various application programs on the program memory module 206. According to one embodiment of the present invention, the processing module 208 may receive signals acquired by the user input receiving module 202 and the sensor module 204, if necessary, and perform appropriate processing on these signals. According to one embodiment of the present invention, the processing module 208 may perform appropriate processing on signals received from the outside via the communication module 210, if necessary.

According to one embodiment of the present invention, the communication module 210 may allow the user terminal 102 to communicate with the interactive AI agent server 106 and/or the external service server 108 via the communication network 104 of FIG. 1. According to one embodiment of the present invention, the communication module 210 may allow the signals acquired by, for example, the user input receiving module 202 and the sensor module 204 to be transmitted to the interactive AI agent server 106 and/or the external service server 108 via the communication network 104 according to a predetermined protocol. According to one embodiment of the present invention, the communication module 210 may receive various signals, for example, a response signal including a natural language response in the form of voice and/or text, or various control signals, from the interactive AI agent server 106 and/or the external service server 108 via the communication network 104, and perform appropriate processing according to a predetermined protocol.

According to one embodiment of the present invention, the response output module 212 may output a response in various forms, such as visual, auditory, and/or tactile forms, corresponding to the user input. According to one embodiment of the present invention, the response output module 212 may include various display devices, such as a touch screen based on such technology as liquid crystal display (LCD), light emitting diode (LED), organic light-emitting diode (OLED), quantum dot light-emitting diode (QLED), or the like, and provide visual responses, for example, text, videos, hyperlinks, animation, various notifications, and the like, corresponding to the user input to the user through the display devices. According to one embodiment of the present invention, the response output module 212 may include, for example, a speaker or a headset, and provide an auditory response, for example, a voice and/or sound response, corresponding to the user input to the user through the speaker or the headset. According to one embodiment of the present invention, the response output module 212 may include a motion/haptic feedback generation unit, and provide a tactile response, for example, a motion/haptic feedback, to the user through the motion/haptic feedback unit. According to one embodiment of the present invention, the response output module 212 may simultaneously provide any two or more combinations of a text response, a voice response, and a motion/haptic feedback,

FIG. 3 is a functional block diagram schematically illustrating a functional configuration of the interactive AI agent server 106 of FIG. 1 according to one embodiment of the present invention. As illustrated, the interactive AI agent server 106 includes a communication module 302, a conversation/task processing unit 304, a conversation flow management model building/updating unit 306, and a conversation log collecting unit 308.

According to one embodiment of the present invention, the communication module 302 allows the interactive AI agent server 106 to communicate with the user terminal 102 and/or the external service server 108 via the communication network 104 according to a predetermined wired or wireless communication protocol. According to one embodiment of the present invention, the communication module 302 may receive a voice input and/or a text input from the user, which is transmitted from the user terminal 102 via the communication network 104. According to one embodiment of the present invention, the communication module 302 may receive status information of the user terminal 102, transmitted from the user terminal 102 via the communication network 104, along with, or separate from, the voice input and/or the text input from the user, which is transmitted from the user terminal 102. According to one embodiment of the present invention, the status information may include, for example, various types of status information regarding the corresponding user terminal 102 (e.g., a physical status of the user terminal 102, a software/hardware status of the user terminal 102, environment status information of the user terminal 102, and the like) at the time of the voice input and/or text input from the user. According to one embodiment of the present invention, the communication module 302 may also perform an appropriate operation to transmit the conversation response (e.g., a natural language response in the form of voice and/or text, etc.), generated by the interactive AI agent server 106 in response to the received user input, to the user terminal 102 via the communication network 104.

According to one embodiment of the present invention, the conversation/task processing unit 304 may receive a user natural language input from the user terminals 102a to 102n via the communication module 302, and process the user natural language input on the basis of a prepared predetermined knowledge model to determine the user's intent that corresponds to the user natural language input. According to one embodiment of the present invention, the conversation/task processing unit 304 may also provide an operation matching with the determined user intent, for example, an appropriate conversation response and/or task execution. According to one embodiment of the present invention, each operation performed by the conversation/task processing unit 302 may be, for example, a conversation response and/or task execution carried out, corresponding to each user's intent, in a sequential flow of subordinate intent groups for providing a corresponding service in a predetermined service domain. For example, under a service domain of product purchase, the conversation/task processing unit 304 may identify that the received user input belongs to an intent group of price inquiry, and execute an appropriate task and/or provide a conversation response according to a task flow and/or a conversation flow pattern of the intent group of price inquiry.

According to one embodiment of the present invention, the conversation flow management model building/updating unit 306 may automatically analyze each conversation log collected by the conversation log collecting unit 307 through various arbitrary methods, and build and/or update a conversation flow management model according to the analysis result. According to one embodiment of the present invention, the conversation flow management model building/updating unit 306 may classify each utterance record into one of predetermined subordinate intent groups through keyword analysis on the conversation logs collected in the conversation log collecting unit 308 in relation to, for example, a predetermined service domain, and group the utterance records of the same subordinate intent group. According to one embodiment of the present invention, the conversation flow management model building/updating unit 306 may recognize, for example, a sequential flow between groups, i.e., subordinate intent groups, as a probabilistic distribution. According to one embodiment of the present invention, the conversation flow management model building/updating unit 306 may construct, for example, the sequential flow between subordinate intent groups in a service domain in the form of a probability graph. According to one embodiment of the present invention, the conversation flow management model building/updating unit 306 may identify, for example, all sequential flows that can occur between subordinate intent groups, determine a probability of occurrence of a flow between the intent groups in the all sequential flows, and acquire therefrom a probabilistic distribution of each sequential flow between the above-described subordinate intent groups.

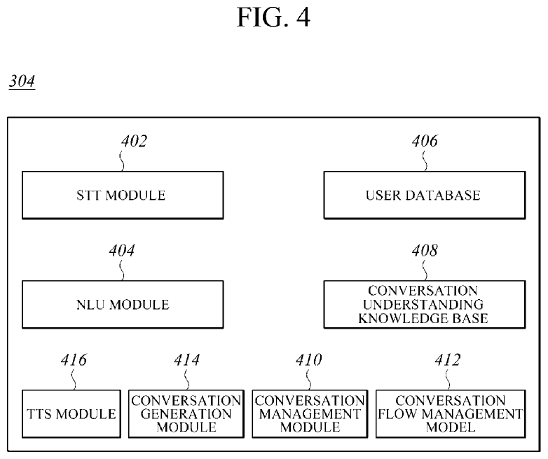

FIG. 4 is a functional block diagram schematically illustrating a functional configuration of the conversation/task processing unit 304 of FIG. 3 according to one embodiment of the present invention. As illustrated, the conversation/task processing unit 302 includes a speech-to-text (STT) module 402, a natural language understanding (NLU) module 404, a user database 406, a conversation understanding knowledge base 408, a conversation management module 410, a conversation flow management model 412, a conversation generation module 414, and text-to-speech (TTS) module 416.

According to one embodiment of the present invention, the STT module 402 may receive a voice input among user inputs received via the communication module 302, and convert the received voice input into text data on the basis of pattern matching or the like. According to one embodiment of the present invention, the STT module 402 may extract features from the voice input of the user and generate a feature vector sequence. According to one embodiment of the present invention, the STT module 402 may generate a text recognition result, for example, a word sequence, on the basis of dynamic time warping (DTW) technique or various statistical models, such as hidden Markov model (HMM), Gaussian mixture model (GMM), deep neural network models, n-gram models, and the like. According to one embodiment of the present invention, the STT module 402 may refer to each user characteristic data in the user database 406, which will be described below, when converting the received voice input into text data on the basis of pattern matching.

According to one embodiment of the present invention, the NLU module 404 may receive a text input from the communication module 302 or the STT module 402. According to one embodiment of the present invention, the text input received by the NLU module 404 may be, for example, a user text input, which has been received by the communication module 302 from the user terminal 102 via the communication network 104, or a text recognition result, for example, a word sequence, which has been generated by the STT module 402 from the user voice input received by the communication module 302. According to one embodiment of the present invention, the NLU module 404 may receive, concurrently with or after receiving the text input, status information associated with the corresponding user input, for example, status information of the user terminal 102 at the time of the corresponding user input. As described above, the status information may be, for example, various types of status information related to the corresponding user terminal 102 (e.g., physical status of the user terminal 102, software and/or hardware status, environment status information of the user terminal 102, and the like) at the time of the user voice input and/or the text input to the user terminal 102.

According to one embodiment of the present invention, the NLU module 404 may match the received text input with one or more user intents on the basis of the conversation understanding knowledge base 408. Here, the user intent may be associated with a series of operations that can be understood and performed by the interactive AI agent server 106 according to the user intent. According to one embodiment of the present invention, the NLU module 404 may refer to the above-described status information when matching the received text input with one or more user intents. According to one embodiment of the present invention, the NLU module 404 may refer to each user characteristic data in the user database 406, which will be described below, when matching the received text input with one or more user intents.

According to one embodiment of the present invention, the user database 406 may be a database that stores and manages user-specific characteristic data. According to one embodiment of the present invention, the user database 406 may include, for example, a record of a user's previous conversation, user's pronunciation feature information, user vocabulary preference, user's location, setting language, contact/friend list, and other various types of user characteristic information for each user.

According to one embodiment of the present invention, as described above, the STT module 402 refers to user characteristic information of each user, for example, user-specific pronunciation features, in the user database 406 when converting the voice input into text data, and thereby may acquire more accurate text data. According to one embodiment of the present invention, when determining the user intent, the NLU module 404 refers to user characteristic data of each user, for example, user-specific characteristics or context, in the user database 407, and thereby may determine more accurate user intent.

In the drawing, the user database 406 which stores and manages the user-specific characteristic data is illustrated as being disposed in the interactive AI agent server 106, but the present invention is not limited thereto. It should be noted that according to another embodiment of the present invention, the user database which stores and manages the use-specific characteristic data may be present in, for example, the user terminal 102, or may be distributively disposed in the user terminal 102 and the interactive AI agent server 106.

According to one embodiment of the present invention, the conversation management module 410 may generate a series of operation flow corresponding to the user intent determined by the NLU module 404. According to one embodiment of the present invention, the conversation management module 310 may determine, on the basis of the conversation flow management model 412, which operation, for example, which conversation response and/or task execution, is to be performed corresponding to the user intent received from the NLU module 404, and generate a detailed operation flow accordingly.

According to one embodiment of the present invention, the conversation understanding knowledge base 408 may include, for example, a predefined ontology model. According to one embodiment of the present invention, the ontology model may be represented by, for example, a hierarchical structure among nodes, wherein each node may be one of an “intent” node corresponding to the user's intent and a child “attribute” node linked to the “intent” node (a node directly linked to the “intent” node or a child “attribute” node linked to an “attribute” node of the “intent” node). According to one embodiment of the present invention, the “intent” node and “attribute” nodes directly or indirectly linked to the “intent” node may form one domain, and an ontology may be composed of a set of such domains. According to one embodiment of the present invention, the conversation understanding knowledge base 408 may be configured to include domains corresponding, respectively, to all intents that an interactive AI agent system understands and performs operations corresponding thereto. It should be noted that according to one embodiment of the present invention, the ontology model may be dynamically changed by adding or deleting a node or modifying a relationship among the nodes.

According to one embodiment of the present invention, an intent node and attribute nodes of each domain in the ontology model may be respectively associated with words and/or phrases related to the corresponding user intent or attributes. According to one embodiment of the present invention, the conversation understanding knowledge base 408 may implement the ontology model in the form of, for example, a vocabulary dictionary (not specifically shown) composed of nodes of a hierarchical structure and a set of words and/or phrases associated with each node, and the NLU module 404 may determine a user intent on the basis of the ontology model implemented in the form of a vocabulary dictionary. For example, according to one embodiment of the present invention, the NLU module 404, upon receiving a text input or a word sequence, may determine with which node of which domain in the ontology model each word in the sequence is associated, and determine a corresponding domain, that is, a user intent, on the basis of the determination.

According to one embodiment of the present invention, the conversation flow management model 412 may include a probabilistic distribution model for a sequential flow between a plurality of subordinate intent groups required for providing a corresponding service, in relation to a given service domain. According to one embodiment of the present invention, the conversation flow management model 412 may include, for example, a sequential flow between the subordinate intent groups, belonging to a corresponding service domain, in the form of a probability graph. According to one embodiment of the present invention, the conversation flow management model 412 may include, for example, a probabilistic distribution of each intent group acquired in various sequential flows that can occur between the subordinate intent groups. According to one embodiment of the present invention, although not specifically illustrated, the conversation flow management model 412 may also include a library of conversation patterns belonging to each intent group.

According to one embodiment of the present invention, the conversation generation module 414 may generate a required conversation response on the basis of the operation flow generated by the conversation management module 410. According to one embodiment of the present invention, the conversation generation module 414, when generating the conversation response, may refer to the user characteristic data (e.g., a record of a user's previous conversation, user's pronunciation feature information, user vocabulary preference, user's location, setting language, contact/friend list, a record of previous conversation for each user, and the like) in the user database 406 described above.

According to one embodiment of the present invention, the TTS module 416 may receive the conversation response generated by the conversation generation module 414 to be transmitted to the user terminal 102. The conversation response received by the TTS module 418 may be natural language or a sequence of words in the form of text. According to one embodiment of the present invention, the TTS module 418 may convert the received input in the form of text into a voice form according to various types of algorithms.

In the embodiment described with reference to FIGS. 1 to 4, the interactive AI agent system is described as being implemented based on a client-server model between the user terminal 102 and the interactive AI agent server 106, in particular, a so-called “thin client-server model,” in which a client provides only a user input/output function and any other functions of the interactive AI agent system are delegated to the server, but the present invention is not limited thereto. It should be noted that according to another embodiment of the present invention, the interactive AI agent system may be implemented by distributing functions thereof between the user terminal and the server, or alternatively, the functions may be implemented as independent applications installed on the user terminal. In addition, it should be noted that according to one embodiment of the present invention, when the interactive AI agent system is implemented by distributing functions thereof between the user terminal and the server, the distribution of each function of the interactive AI agent system between the client and the server may be implemented differently for each embodiment. Also, in the embodiment of the present invention described above with reference to FIGS. 1 to 4, for convenience of description, specific modules have been described as performing predetermined operations, but the present invention is not limited thereto. It should be noted that according to another embodiment of the present invention, the operations described as being performed by any specific module may be respectively performed by other separate modules different from the specific module.

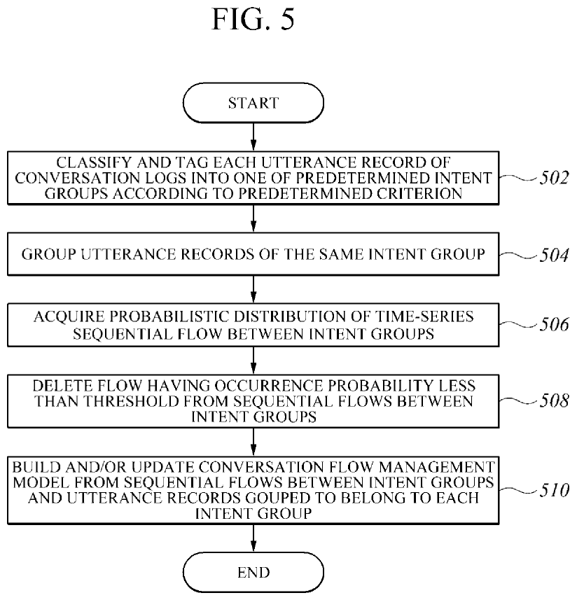

FIG. 5 is a flowchart of exemplary operations performed by the conversation flow management model building/updating unit 306 of FIG. 3 according to one embodiment of the present invention.

In step 502, for conversation logs collected in relation to a specific service by various methods, the conversation flow management model building/updating unit 306 may classify and tag each of utterance records of the conversation logs into one of predetermined intent groups according to a predetermined criterion. According to one embodiment of the present invention, the utterance records may be generated and provided by, for example, a user or a specific system. According to one embodiment of the present invention, the predetermined intent groups may be, for example, subordinate intent groups belonging to a given service domain. According to one embodiment of the present invention, the conversation flow management model building/updating unit 306 may classify and tag each utterance record into one of subordinate intent groups of, for example, product inquiry, brand inquiry, design inquiry, price inquiry, and return inquiry belonging to a service domain of product purchase. According to one embodiment of the present invention, the conversation flow management model building/updating unit 306 may perform keyword analysis on each of the utterance records of the collected conversation logs and classify and tag each utterance record into one of the predetermined intent groups according to a keyword analysis result. According to one embodiment of the present invention, the conversation flow management model building/updating unit 306 may preselect keywords related to each intent group and classify each utterance record into a specific intent group on the basis of the selected keyword.

In step 504, for the utterance records classified and tagged into any one of the plurality of intent groups, the conversation flow management model building/updating unit 306 may group the utterance records of the same intent grouped. According to one embodiment of the present invention, each of the utterance records grouped into the same intent group may be included in the conversation flow management model as conversation patterns of the corresponding intent group.

In step 506, the conversation flow management model building/updating unit 306 may acquire a probabilistic distribution of a time-series sequential flow between the intent groups on the basis of the sequential flow of the utterance records, grouped into each intent group, in each conversation log. According to one embodiment of the present invention, in the case of a service domain of product purchase, assuming that subordinate intent groups belonging to the service domain are product inquiry, brand inquiry, design inquiry, price inquiry, and return inquiry, there may be, for example, as the first-occurring intent group, a product inquiry at a probability of 70%, a brand inquiry at a probability of 20%, a design inquiry at a probability of 5%, a price inquiry at a probability of 3%, and a return inquiry at a probability of 2%, and after the product inquiry, there may be a brand inquiry at a probability of 65%, a design inquiry at a probability of 21%, a price inquiry at a probability of 13%, and a return inquiry at a probability of 1%. Each of the intent groups may be stratified as the probabilistic distribution of such a sequential flow. According to one embodiment of the present invention, the conversation flow management model building/updating unit 306 may construct, for example, the sequential flow between subordinate intent groups in a service domain in the form of a probability graph. According to one embodiment of the present invention, the conversation flow management model building/updating unit 306 may recognize, for example, all sequential flows that can occur between the subordinate intent groups, determine, from the conversation logs, an occurrence probability of a flow between the intent groups among all the sequential flows, and acquire therefrom a probability distribution of each sequential flow between the subordinate intent groups. It should be noted that according to one embodiment of the present invention, the probabilistic distribution of each sequential flow between the intent groups may be acquired based on a statistical method or a neural network method.

In step 508, when the analysis result of the probabilistic distribution of the time-series sequential flow between the intent groups indicates that the occurrence probability of the time-series sequential flow between the intent groups is less than a threshold, the conversation flow management model building/updating unit 306 may delete the corresponding flow from the probabilistic distribution acquired above. For example, when the threshold is set to an occurrence probability of 2%, if a probability of occurrence of a return inquiry after a product inquiry, in a service domain of product purchase, is 1%, a flow in which a return inquiry occurs after the product inquiry may be deleted from the generated sequential flow between the intent groups.

In step 510, the conversation flow management model building/updating unit 306 may generate and/or update the conversation flow management model 412 from the sequential flow between the intent groups (e.g., a probabilistic distribution of the sequential flow between the intent groups) and each of the utterance records grouped to belong to each intent group. According to one embodiment of the present invention, when the interactive AI agent system intents to provide a new service, various conversation logs related to the new service may be collected, and the conversation flow management model building/updating unit 306 may newly build a conversation flow management model for the corresponding service on the basis of the collected conversation logs. According to one embodiment of the present invention, while the interactive AI agent system is providing a specific service on the basis of a predetermined conversation flow management model, the interactive AI agent system may continuously collect conversation logs in relation to the provision of the corresponding service and the conversation flow management model building/updating unit 306 may continuously update the conversation flow management model on the basis of the collected conversation logs.

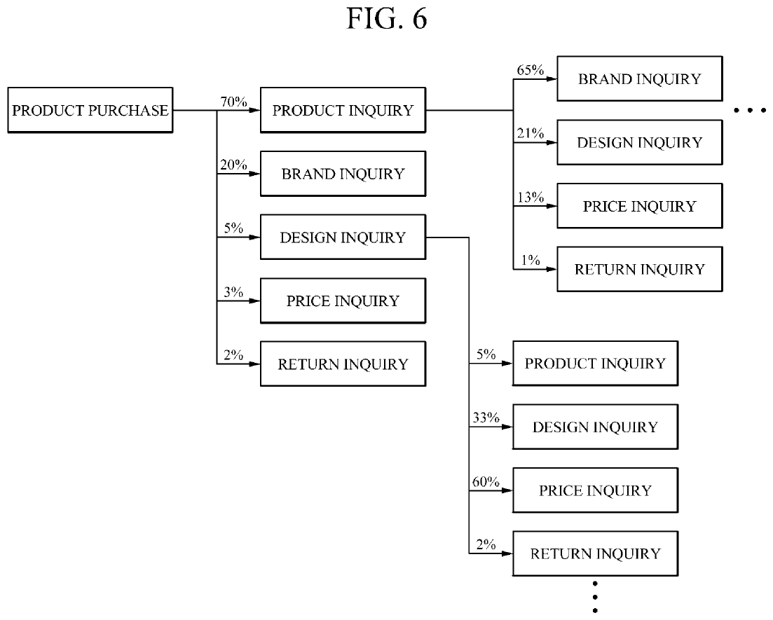

FIG. 6 is a diagram illustrating a part of a probability graph of a sequential flow of each intent group of a service, which is constructed according to one embodiment of the present invention. This drawing is intended to illustrate, with respect to FIG. 5, only a part of a probabilistic distribution of a sequential flow of each subordinate intent group of a service domain of product purchase, and is merely illustratively presented to assist in understanding the present invention. It should be understood, however, that there is no intent to limit the invention to particular forms disclosed.

It will be understood that the present invention is not limited to the examples given hereinabove, and that various changes, substitutions, and alternations may be made herein without departing from the scope of the invention. It will be understood that the units and/or modules described herein may be implemented using hardware components, software components, and/or combination of the hardware components and the software components.

A computer program according to one embodiment of the present invention may be implemented as being stored in various types of computer-readable storage media. The storage media readable by a computer processor or the like include, for example, volatile media such as EPROM, EEPROM, and a flash memory device, a magnetic disk, such as a built-in hard disk and a detachable disk, a magneto-optical disk, and a CDROM disk. Further, program code(s) may be implemented in machine language or assembly language. It is intended in the appended claims to cover all changes and modifications that follow in the true spirit and scope of the invention.

1. A method for automatically building or updating a conversation flow management model for an interactive artificial intelligence (AI) agent system, which is performed by a computing device, the method comprising:
collecting a plurality of conversation logs related to a service domain, wherein the service domain includes a plurality of intent groups and each of the conversation logs includes a plurality of utterance records;
classifying each of the plurality of utterance records into one intent group among the plurality of intent groups, according to a predetermined criterion;
grouping utterance records classified into each corresponding intent group, for each of the plurality of intent groups;
acquiring a probabilistic distribution of a time-series sequential flow between the plurality of intent groups, based on a sequential flow of the plurality of utterance records in each of the plurality of conversation logs; and
building or updating a conversation flow management model for a service so as to include the acquired probabilistic distribution of the time-series sequential flow between the plurality of intent groups.

2. The method of claim 1, wherein the acquiring of the probabilistic distribution is performed based on a statistical method or a neural network method.

3. The method of claim 1, wherein each of the plurality of intent groups is associated with one or more keywords; and
the classifying of each of the plurality of utterance records into one intent group among the plurality of intent groups comprises:
determining whether each of the plurality of utterance records includes the one or more keywords associated with each of the plurality of intent groups; and
classifying each of the plurality of utterance records into one intent group among the plurality of intent groups based on the determination.

4. The method of claim 1, wherein the building or updating of the conversation flow management model for the service comprises causing the conversation flow management model to include the utterance records grouped corresponding to each of the plurality of intent groups.

5. The method of claim 1, wherein the acquiring of the probabilistic distribution of the time-series sequential flow between the plurality of intent groups further comprises:
identifying all sequential flows that can occur between the plurality of intent groups; and
determining, from each of the plurality of conversation logs, an occurrence probability of each sequential flow between the plurality of intent groups among all the sequential flows.

6. The method of claim 5, wherein the acquiring of the time-series sequential flow between the plurality of intent groups comprises acquiring the probabilistic distribution of the time-series sequential flow between the plurality of intent groups by excluding a sequential flow having an occurrence probability thereof less than a threshold from the sequential flows between the plurality of intent groups.

7. A computer-readable recording medium having one or more instructions stored thereon which, when executed by a computer, cause the computer to perform the method of claim 1.

8. A computer apparatus for automatically building or updating a conversation flow management model for an interactive artificial intelligence (AI) agent system, the computer apparatus comprising:
a conversation flow management model building/updating unit; and
a conversation log collecting unit configured to collect and store a plurality of conversation logs related to a service domain, wherein the service domain includes a plurality of intent groups and each of the conversation logs includes a plurality of utterance records,
wherein the conversation flow management model building/updating unit is configured to:
receive the plurality of conversation logs from the conversation log collecting unit;
classify each of the plurality of utterance records into one intent group among the plurality of intent groups, according to a predetermined criterion;
group utterance records classified into each corresponding intent group, for each of the plurality of intent groups;
acquire a probabilistic distribution of a time-series sequential flow between the plurality of intent groups, based on a sequential flow of the plurality of utterance records in each of the plurality of conversation logs; and
build or update a conversation flow management model for a service so as to include the acquired probabilistic distribution of the time-series sequential flow between the plurality of intent groups.
